(19) United States
(12) Patent Application Publication
(10) Pub. No.: US 2026/0162200 A1
(43) Pub. Date: Jun. 11, 2026

(54) COMPUTER TOOL FOR DETERMINING APPLICABLE LEGAL CLAIMS FROM A FACT PATTERN

(71) Applicant: Thomson Reuters Enterprise Centre GmbH, Zug (CH)

(72) Inventors: Jesse McCrillis Carlson, Cottage Grove, MN (US); Jonathan Edward Germann, Black Mountain, NC (US)

(21) Appl. No.: 19/181,065

(22) Filed: Apr. 16, 2025

Related U.S. Application Data
(60) Provisional application No. 63/634,746, filed on Apr. 16, 2024.

(51) Int. Cl. G06Q 50/18

(52) U.S. Cl. CPC G06Q 50/18

(57) ABSTRACT

A system and method for using a large language model to automatically identify legal claims or legal causes of action that may apply to a fact pattern provided by a user are described. Automatically determining a legal claim from the fact pattern may include using a structured data collection and a large language model to address a fact pattern and suggest potentially valid causes of action. For each potential legal claim, the systems and methods may, as nonlimiting examples, identify whether the user a) has a potentially valid claim fully supported by the fact pattern, b) might have a potentially valid claim if additional facts were present, or c) does not appear to have a valid claim. The system may then generate a description of the potential claims, framed in terms of the user's facts, and display the description at a display of a graphical user interface.

### CROSS-REFERENCE TO RELATED APPLICATIONS

The present application claims the benefit of priority from U.S. Provisional Application No. 63/634,746 filed Apr. 16, 2024, and entitled “COMPUTER TOOL FOR DETERMINING APPLICABLE LEGAL CLAIMS FROM A FACT PATTERN,” the disclosure of which is incorporated by reference herein in its entirety.

### TECHNICAL FIELD

The present application is generally directed to computer based tools for legal research, and more particularly to systems and methods for automatically determining applicable legal claims from a fact pattern.

### BACKGROUND

The ability to determine a legal claim is a task that requires special skill and knowledge obtained through years of education and on-the-job training in the legal profession. Even after attaining the requisite level of skill, it takes a tremendous amount of time to research what potential claims might be available based on a fact pattern. Once research on a fact pattern has begun, a user of a research system is typically presented with a long list of legal cases in the field as a conventional search result, rather than being presented with a determination of a legal claim based upon the fact pattern.

The research itself is also very difficult at least in part because it is based on facts and legal claims that may be expressed in similar ways but which may cause language variety problems. Applying machine learning tools such as large language models (LLMs) to address language variety in different statutes and treatment of the statutes in court cases is a potential solution. However, machine learning tools often do not perform with the level of accuracy and precision that is required for legal analysis. A LLM tool could theoretically be configured to analyze every statute in a jurisdiction to determine its applicability to a legal claim, but that includes a layer of interpretation that is challenging even for humans: as an example, lawyers argue whole cases over statutory interpretation.

While LLM tools currently available may be able to summarize common law, they are poor at statutory interpretation and application of general principles of law to fact patterns. Machine learning models currently available, including models configured to perform retrieval augmented generation (RAG) are not well-equipped to identify legal claims from statements of facts. This is because such models lack the granularity to identify such legal claims while still compensating for language variation possibilities in a user's natural language statement of facts. LLMs have also been known to hallucinate fake law when applied to analyzing legal claims. Even well-trained conventional systems simply lack the level of granularity necessary to identify relevant legal causes of action from user provided statements of fact.

### SUMMARY

Systems and methods are provided herein for automatically determining a legal cause of action from a provided fact pattern (also referred to herein as a statement of facts). In some configurations, the systems and methods include using a language model (e.g., an LLM) trained to identify causes of action from common law, federal statutes, state statues, federal constitutional law, state constitutional law, or a combination thereof. The language model may be configured to operate on a user's textual description of facts using one or more legal claims records stored in a structured data collection, and to generate an explanation of the potentially viable legal claims based on the user's statement of facts. The system may provide a graphical user interface to which a user may input a statement of facts and at which a description of potentially applicable legal causes of action can be displayed to the user.

The ability to automatically determine legal causes of action may save significant time and money for legal professionals in evaluating a client's case. Systems and methods such as those described herein can provide greater flexibility and insights for legal professionals and for researchers in determining legal causes of action. For example, systems and methods disclosed herein may enable a user to identify several potentially viable causes of action for a given fact pattern in minutes or less, where conventional claims research could take hours or days to do effectively. Moreover, systems and methods such as those described herein can prevent loss of face by allowing legal professionals to identify the best causes of action in the first instance and avoid having to amend complaints and fight successive motions to dismiss.

Moreover, the systems and methods described herein provide for technical improvements over conventional generative artificial intelligence or machine learning systems and methods. Prior systems for analyzing potential legal claims lacked sufficient granularity to identify and explain specific legal causes of action present in statutes while retaining and applying contextual information from fact patterns provided to the system. The solutions described herein can perform granular analysis of applicable claims from statutory law by applying a focused language component in the form of one or more legal claim records to the fact pattern. The legal claim records may form a database including conduct descriptors, and the database may be both lightweight and extensive. Such a database of conduct descriptors may be quickly evaluated by a language model within the context of a statement of facts to determine one or more causes of action applicable to the statement of facts.

In an aspect of the present disclosure, a computer-implemented method for processing a fact pattern to identify applicable legal claims is disclosed. The computer-implemented method may include storing, in a non-transitory computer-readable medium, a structured data collection comprising a plurality of legal claim records, where each legal claim record of the plurality of legal claim records comprises a record identifier, and one or more conduct descriptors corresponding to one or more essential elements. The computer-implemented method may further include receiving, from a user via an input device, a first set of information comprising a textual description of a fact pattern. The computer-implemented method may further include processing, by one or more processors, the first set of information using a language model to extract a second set of information comprising one or more identified elements present in the first set of information. The computer-implemented method may further include generating, by the one or more processors, a filtered subset of the structured data collection by selecting legal claim records having at least one conduct descriptor with at least one essential element corresponding to at least one of the one or more identified elements. The computer-implemented method may further include applying, by the one or more processors, the language model to each legal claim record in the filtered subset and the first set of information to generate a classification output. The classification output may assign each legal claim record to one classification selected from a classification set including: a first classification indicating the legal claim is supported by the first set of information, a second classification indicating the legal claim requires additional information beyond the first set of information, and a third classification indicating the legal claim is not supported by the first set of information. The computer-implemented method may also include generating, by the one or more processors, for each legal claim record assigned to the first classification or the second classification, an output of a relationship between the first set of information and the legal claim record. The computer-implemented method may further include outputting, to a display, a result data structure comprising data associated with legal claim records assigned to the first classification or the second classification and the explanatory output for each such legal claim record.

In an additional aspect of the present disclosure, a method is provided for determining a legal cause of action. The method includes receiving, with a computer system, data from at least one data source and determining a conduct description based upon the data. The method also includes determining, with the computer system, a statement of facts that meet the conduct description. The method also includes receiving, with the computer system, a fact pattern and determining a filtered data set that includes conduct descriptions related to the fact pattern. The method also includes generating, with the computer system using a large language model, a result of at least one of: if the fact pattern matches the conduct description, partially matches the conduct description, or does not match the conduct description. The method also includes generating, with the computer system using a large language model, an explanation for how the conduct description relates to the fact pattern.

The foregoing broadly outlines the features and technical advantages of the present disclosure in order that the detailed description of the invention that follows may be better understood. Additional features and advantages will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. It is to be expressly understood that each of the figures is provided for the purpose of illustration and description only and is not intended as a definition of the limits of the present invention.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of a fact pattern analysis system in accordance with aspects of the present disclosure.

FIG. 2 is a block diagram illustrating example data flow operations of a fact pattern analysis system in accordance with aspects of the present disclosure.

FIG. 3 illustrates an exemplary graphical user interface for inputting a statement of facts in accordance with aspects of the present disclosure.

FIG. 4 illustrates an exemplary graphical user interface for outputting a legal cause of action in accordance with aspects of the present disclosure.

FIG. 5 is a flow diagram of an exemplary method for determining a legal claim in accordance with aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive may have been omitted. It should be understood, of course, that this disclosure is not limited to the particular embodiments illustrated herein.

### DETAILED DESCRIPTION

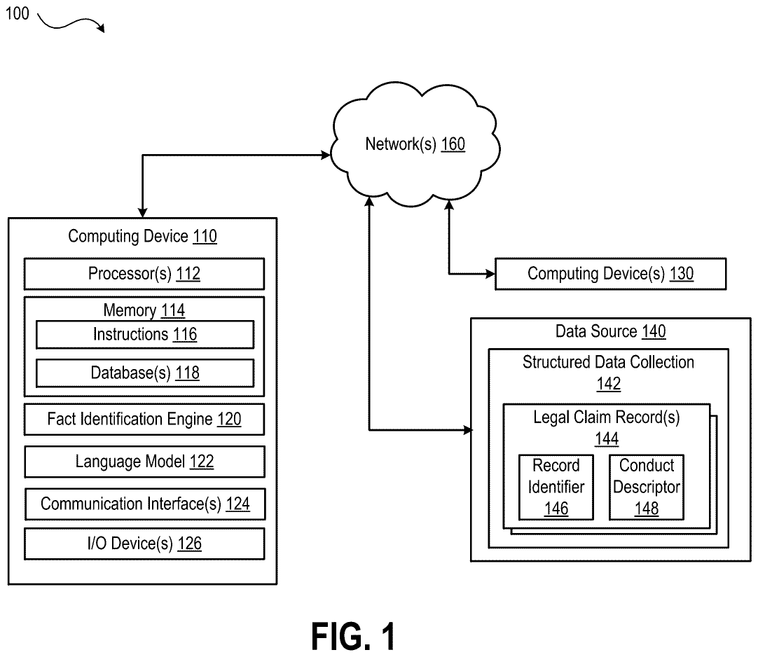

In FIG. 1, a block diagram of a fact pattern analysis system in accordance with aspects of the present disclosure is shown as a system 100. The system 100 may be configured to receive a statement of facts, for example by an input to an input device. From the statement of facts, the system 100 may identify one or more legal claims that may apply to the statement of facts and/or or legal causes of action which may be brought based on the statement of facts. The system 100 may generate a written description of how the one or more legal claims are related to facts in the statement of facts. The system 100 may also identify additional legal claims that may apply to the statement of facts if additional facts missing from the statement of facts are provided. The system 100 may generate a written description of how relevant additional facts, if present, would be related to the additional legal claims. The system 100 may be configured to display the written description at a graphical user interface of the system 100. Exemplary details regarding the above-identified functionality of the system 100 are described in greater detail below.

As illustrated in FIG. 1, the system 100 includes a computing device 110 that includes one or more processors 112, a memory 114, a fact identification engine 120, a language model 122, one or more communication interfaces 124, and input/output (I/O) devices 126. The one or more processors 112 may include a central processing unit (CPU), graphics processing unit (GPU), a microprocessor, a controller, a microcontroller, a plurality of microprocessors, an application-specific integrated circuit (ASIC), an application-specific standard product (ASSP), or any combination thereof. The memory 114 may comprise read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. The memory 114 may store instructions 116 that, when executed by the one or more processors 112, cause the one or more processors 112 to perform operations described herein with respect to the functionality of the computing device 110 and the system 100. The memory 114 may further include one or more databases 118, which may store data associated with operations described herein with respect to the functionality of the computing device 110 and the system 100.

The communication interface(s) 124 may be configured to communicatively couple the computing device 110 to the one or more networks 160 via wired and/or wireless communication links according to one or more communication protocols or standards. The I/O devices 126 may include one or more display devices, a keyboard, a stylus, a scanner, one or more touchscreens, a mouse, a trackpad, a camera, one or more speakers, haptic feedback devices, or other types of devices that enable a user to receive information from or provide information to the computing device 110.

The one or more databases 118 may include one or more document databases for storing documents. Non-limiting examples of documents that may be stored in a document database of the databases 118 include case law documents, federal statutes, state statutes, constitutions, legal codes, legal briefs, legal motions, court filings, regulatory rules, journal articles, commentaries, treatises, and/or news articles. Documents may include or correspond to state and/or federal law. Additionally or alternatively, documents, metadata, and/or other information may be stored on and/or retrieved to the computing device 110 from other devices such as, for example, computing device(s) 130 or from a data source and/or a plurality of data sources, such as, data source 140. Such devices and/or data sources may be communicatively coupled with the computing device 110 through the one or more networks 160.

Data source 140 may include a non-transitory computer-readable medium configured to store and retrieve data. The data source 140 may include one or more document databases for storing or accessing documents. Non-limiting examples of documents that may be stored in a document database of the data source 140 include case law documents, federal statutes, state statutes, constitutions, legal codes, legal briefs, legal motions, court filings, regulatory rules, journal articles, commentaries, treatises, and/or news articles. Documents may include or correspond to state and/or federal law. In some configurations, a data source may include documents corresponding to areas outside of law or statutes, such as Securities Exchange Commission (SEC) filings, as a non-limiting example.

The data source 140 may include a structured data collection 142. Structured data collection 142 may be configured as a database (e.g., a SQL database) or converted to a SQL database from another format. For example, in some configurations, the structured data collection 142 may be implemented as a csv file that may be converted to a SQL database. The csv file may be implemented with a JSON format or a similar format.

The structured data collection 142 may include a plurality of legal claim records 144. Each legal claim record of the plurality of legal claim records 144 may include fields or data objects containing information corresponding to a legal claim. For example, the legal claim record may include a record identifier 146 and a conduct descriptor 148. The data objects or fields for a legal claim record may include fields for any combination of a ClaimsID, a citation, a title, one or more popular names, a long description, a short description, or one or more “minimum facts” of the legal claim. An example of the structure of the legal claim record in a JSON-like syntax is illustrated in example 1 below:
(1) {ClaimsID: id#, Title: Statute Title, Citation: Citation at the subsection/lowest level, Popular Names: Any popular names of the statute/act, Long Description: Long description text, Short Description/Examples: Short description text, minimum facts: minimum fact descriptors}

In some configurations, one or more of the data objects or fields for each legal claim record of the plurality of legal claim records 144 may include field names in addition to the information corresponding to the legal claim. For example, a citation field, a long description field, and/or a short description field may include field names formatted in a JSON format or a similar format. Such a format may be useful as a lightweight data structure that is easily read and operated on. Such a format may also facilitate the input of the legal claim records into a trained machine learning model (e.g., language model 122) as part of the system performing an analysis of a statement of facts, according to operations described in greater detail herein.

The data objects or fields described here are for illustrative purposes, and alternative configurations could be implemented without departing from the spirit and scope of this disclosure. In some configurations, there may be some overlap between one or more of the data objects or fields. For example, the record identifier 146 may include one or more identifying features of the legal claim record, such as a Claim ID (which may also be expressed as “ClaimsID”), a citation, a title, or a popular name. The identifying features may include a public identifier of the legal claim record (e.g., a legal citation) or the identifying features may be configured using a proprietary identifier (e.g., a reference number or index, such as a Westlaw Key Number®).

The conduct descriptor 148 may include one or more descriptions of conduct associated with a legal claim. For example, conduct descriptor 148 may include a long description, a short description, or one or more minimum facts of the legal claim.

Long Descriptions describe the kind of conduct that may be actionable under a statute or common law claim in general terms. Long descriptions also may include terms that might facilitate good output from a language model. Long descriptions can also include specific instructions designed to prevent a language model from applying an inapplicable cause of action to a statement of facts. An example Long Description with respect to United States federal law under 10 U.S.C.A. § 987(b) is as follows: “10 U.S.C.A. § 987(b), also known as Section 987(b) of the Military Lending Act, states that annual interest rates may not exceed 36 percent with regard to consumer credit. This statute applies to active duty military personnel and their dependents. Do not apply this statute to inactive or retired military personnel or their dependents.” In this example, the “Do not apply” language in the long description functions as an instruction to the language model that may cause it to only apply the statute to applicable fact patterns.

Short Descriptions give an abstract statement of a set of facts that, if true about the fact pattern, means there is a viable cause of action. In the example of 10 U.S.C.A. § 987(b), a short description could be as follows: “An active duty military servicemember or their dependent was charged more than 36 percent APR on a loan.” For other causes of action, there may be multiple short descriptions. For example, if there were multiple elements to a cause of action, each element may need its own short description.

Minimum facts are facts related to a type of conduct that would always trigger a cause of action from the conduct. In this sense, a minimum fact may be considered an essential element of the cause of action. The type of conduct captured by a minimum fact could give rise to one or more causes of action under a statute, common law, constitutional law, a regulation, or a combination thereof. Minimum facts may be described in the alternative to each other. In some configurations, the minimum facts may be described in the broadest terms possible. A reason for including broad minimum facts is that when the minimum facts are provided to a language model (e.g., language model 122), they may trigger the language model to identify claims that may be related. For example, minimum facts may be designed to elicit a target behavior from a model of identifying potential viable claims that may be brought based on a statement of facts. Minimum facts might also enable the language model to identify additional facts missing from the statement of facts, which, if determined to be present, would suggest one or more additional potential viable claims.

In the example of 10 U.S.C.A. § 987(b), minimum facts might include descriptors such as the following: involves a military servicemember or military dependent; involves a transaction; involves a loan; involves a lender; involves a bank. In this example, if a statement of facts involved a loan with more than 36 percent APR, but did not include details about a military servicemember or dependent, a language model provided with the statement of facts and the minimum facts may be able to respond to the statement of facts with an indication of additional facts needed to determine a potential cause of action under 10 U.S.C.A. § 987(b). An example output from the language model could be presented to a user in generated natural language like this: “Your facts don't tell us this, but if this person was a military member or dependent they might have a claim under 10 USC 987.”

A conduct descriptor of a minimum fact may be configured in a highly granular manner. For example, a conduct descriptor may be a description of the kind of conduct involved (e.g., “involves a transaction,” “involves a communication”, “involves a lack of communication,” “involves trespassing,” and so on), a description of the kind of parties involved in a cause of action (e.g., “involves an employee,” “involves a landlord,” “involves a tenant,” “involves a fiduciary,” and so on), or a description of circumstances relative to the cause of action (e.g., “involves a computer,” “involves data being stored on a server,” “involves a bank” and so on). These examples are by no means exhaustive, nor are they necessarily representative of all types of conduct that may be included in a legal claim record, as there may be hundreds or thousands of individual conduct descriptors that may give rise to some cause of action. At the same time, if a type of conduct may be appropriately be identified as a minimum fact for more than one cause of action, it can be beneficial to have in legal claim records for the causes of action, a conduct descriptor that is the same for each cause of action. As an example, there may be significant overlap between a federal cause of action and a state cause of action for the same underlying conduct. Additionally, some causes of action may share at least some of their essential elements with other causes of action. This kind of granular conduct description thus enables the system described herein to identify multiple potentially applicable causes of action from one statement of facts.

Many legal claim records will have “none” in the minimum facts field because there is no guaranteed item that will always be in a user input (e.g., a statement of facts) for some causes of action. This can be especially true for legal claim records corresponding to statutes or common law causes of action with a broad range of potential actionable behavior. Moreover, to account for variations in natural language in both statements of facts and legal causes of action, it is beneficial to have a category that broadly captures potential relevant causes of action for a given set of facts. To illustrate, even a statute about oil spills won't always involve language that specifically says “oil spill.” Where a cause of action could be brought from different actions, it may be better to leave the minimum facts field at “none” to not exclude conduct that is a language variation of the conduct. A benefit of the fact pattern analysis system described herein is that it may be used as a brainstorming tool. Broad initial capture of legal claim records can be achieved by not overly narrowing the pool of legal claim records based on minimum facts or another field of the legal claim records. In some configurations, a broad capture of relevant or potentially relevant legal claim records can prevent missing potentially viable claims during the review and evaluation process.

Returning to the example of FIG. 1, computing device 110 may include a fact identification engine 120. Fact identification engine 120 may be configured to extract facts or keywords from a statement of facts input to the system by a user through one or more of the I/O devices 126. For example, fact identification engine 120 may extract features from a statement of facts that are relevant to one or more causes of action. One way this may be done is by identifying all of the facts in the statement of facts that may be connected to a cause of action. At the stage of data processing that is the fact identification engine 120 it may be more desirable to identify a broad group of facts that could even charitably be said to support a cause of action. Applying too heavy filtering with the fact identification engine 120 may cause fewer viable causes of action to be output from the remaining components of the system.

In some configurations, the fact identification engine 120 may be configured to identify minimum facts or essential elements of the facts provided in the statement of facts. For example, the fact identification engine 120 may extract facts from the statement of facts and format or rephrase the extracted facts so that they may more closely resemble the essential elements or minimum facts included as part of the conduct descriptors 148 of legal claim records 144. In this regard, the fact identification engine 120 may include a language model trained to generate such conduct descriptors. In some configurations, the fact identification engine 120 may be provided with conduct descriptors as examples of how to format the extracted facts so as to take advantage of the structure of the models of the system 100. In some configurations, conduct descriptors may be generated by human editorial reviewers. Additionally or alternatively, however the conduct descriptors are generated, the conduct descriptors may be tested using one or more language models (e.g., language model 122) to determine the effectiveness of the conduct descriptor at identifying a relevant cause of action. In some configurations, conduct descriptors may be generated by a generative machine learning model trained to generate the conduct descriptors. Conduct descriptors may be developed or formatted to take advantage of the mathematics of large language models to identify several potential causes of action that may apply to fact patterns.

Computing device 110 may include a language model 122. Language model 122 may be configured to receive as inputs a user statement of facts or a set of facts as extracted or formatted by fact identification engine 120. Language model 122 may also be configured to receive an input of at least part of a structured data collection 142 (e.g., one or more legal claim records of the plurality of legal claim records 144). Language model 122 may be configured to generate an output identifying a relationship between legal causes of action associated with the legal claim records 144 and the statement of facts. Language model 122 may be further configured to generate an explanation of how the legal causes of action relate to the facts identified by fact identification engine 120.

Language model 122 may be a trained machine learning model, such as a large language model (LLM) or another machine learning model trained to receive natural language inputs and generate natural language outputs. The language model 122 may be specifically trained to connect fact patterns with legal claim records. For example, the language model 122 may be trained on statutory data, common law, legal filings, legal treatises, and the like. Additionally or alternatively, the language model 122 may be implemented using a commercially available language model (or an “out of the box” LLM), such as GPT 3.5, GPT 4 or another similar large language model.

In cases when “out of the box” large language models like GPT 4 are used for the language model 122, the formatting of data for input to the language model, as was discussed above with respect to fact identification engine 120 may be particularly important. Existing language models tend to be weak at identifying statutory causes of action, for example, without receiving input data that causes the language model to identify truly actionable causes of action. One reason for this is that large language models lack context for legal frameworks and may falsely identify causes of action in statutory provisions that do not give rise to a cause of action. For example, on their own, existing LLMs do not recognize when a statutory provision does or does not include prohibited or required conduct that would be connected to an actionable legal claim. Thus, the format of both the statement of facts received from the user and the legal claim records 144 are important structural elements of the language model 122.

Commercially available LLMs also tend to be overinclusive in terms of the results for potential causes of action that may be brought based on a statement of facts. While broad and inclusive causes of action are useful in identifying the universe of potential claims that may be brought based on a set of facts, if the universe is too broad or too tangentially related to the facts provided, the value of the tool for identifying claims is diminished. For example, if a statement of facts were input such as “My client's neighbor stole her golf cart and drove it into a pond on her property,” the universe of potential claims would likely include conversion, trespass, and possibly nuisance. In this example, the language model 122 may further identify the possibility of other claims, given more information. For example, the golf cart fact pattern may prompt an output such as this: “If this appears to be motivated by race or gender, your client may have a Bane Act claim.” But it would not make sense for the model to identify unreasonable possibilities. In the golf cart example, asking “was this part of a pattern of human trafficking?” would be unreasonable because nothing in the fact pattern would suggest that human trafficking plays a role in the misuse of a golf cart. In other words, the granular conduct descriptors 148 may cause the language model 122 to identify and generate more accurate and relevant results. In some configurations, the conduct descriptors 148 may function as a filter that prevents unrelated outputs from being generated.

Language model 122 may determine matches between the statement of facts and the conduct descriptors in the legal claim records. From such matches or lack of matches, the language model 122 may identify potentially applicable claims for the statement of facts provided. The language model 122 may generate a description of applicable legal claims in terms of the facts provided to the system in the statement of facts. The language model 122 may be configured to also generate a description of claims that do not apply or a description of claims that may apply if additional facts are provided. In some configurations, the language model 122 may perform identification of claims or potential causes of action down to the romanette level (or below) of a statute division that has unique prohibited or required behavior that can lead to a private cause of action.

The claim identification process performed by the system using language model 122 to operate on a statement of facts as described herein is a different process than existing processes for retrieval augmented generation (RAG), in which generative artificial intelligence models are provided with additional documents at the time of a query generation. In structuring the language model 122 to identify claims as exemplified by the description herein, the resulting identified claims may avoid issues caused by RAG methods, including a tendency to only generate the “best” or “most popular” claims. RAG methods are not necessarily effective in retrieving or evaluating all possible claims. Where the language model 122 differs from a RAG approach is that the language model 122 functions as an evaluator of all (or at least a large subset) of the potential claims that may be brought, rather than as a generator for a few of the best, most popular, or closest fitting claims.

RAG methods for claim identification may also be more susceptible to difficulties in language variety from an input query than the described language model 122. One reason for this is that performing a search or a retrieval using statutory language instead of an evaluation of potential causes of action tends to generate only abstracted descriptions of behavior—because the retrieval is accessing the abstracted description of the statute—not the more concrete descriptions of behavior described by a user in submitting a fact pattern. This may be compounded by difficulties in interpreting statutory language. In some configurations, the language model 122 may also be more tolerant of a lack of description of important facts in the statement of facts provided. Litigation documents (e.g., court filings, complaints, and so on) that may be searched using RAG to identify potential claims would also generally be poor targets for identifying claims because of case-specific facts in the court documents, and because litigation documents often discuss facts outside of theories of liability. Moreover, litigation documents often discuss facts as applying to all causes of action, regardless of the claims being brought that or facts included in connection with one of the causes of action. A language model 122 as described herein can thus be advantageously configured to perform claim evaluation over a more conventional RAG search and retrieval method.

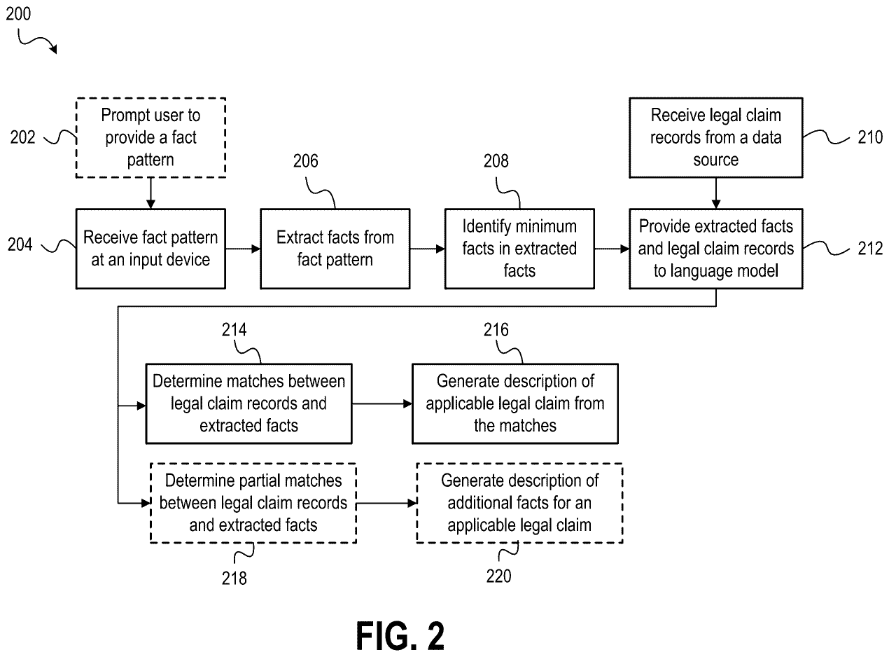

Reference is now made to FIG. 2, in which a block diagram illustrating example data flow operations of a fact pattern analysis system in accordance with aspects of the present disclosure is shown as flow diagram 200. Flow diagram 200 illustrates an example data flow that the system 100 may follow in receiving a statement of facts from a user and generating potential causes of action based on the statement of facts.

At optional block 202 the system may prompt a user to provide a fact pattern (e.g., a statement of facts) using an input device (e.g., I/O device 126). For example, the system may provide a prompt at a graphical user interface (GUI) that gives instructions to a user on the structure or content of a fact pattern that may help elicit useful claim recommendations. For example, the system 100 may prompt a user to describe facts in natural language, or to provide a few sentences of description. In some configurations, a prompt may instruct a user in properties of effective fact pattern queries, such as instructions to describe the fact pattern in general language or to describe the types of parties involved, rather than the names of parties. The prompt may also provide caution to a user that the system uses language models to generate content and that claims identified should be verified with additional research.

At block 204 the system may receive a fact pattern (e.g., a statement of facts) from a user at an input device. The statement of facts may be input, for example through typing into a text box, by speaking into a microphone, by uploading a document including the statement of facts, by selecting a previously generated statement of facts from a drop down menu, or other methods for inputting a fact pattern with an input device as are known in the art.

At block 206, the facts may be extracted from the fact pattern. For example, operations to extract facts from the fact pattern may be performed by the fact identification engine 120. Extracting the facts from the fact pattern may include formatting the facts to match a format that a language model can effectively operate on. At block 208, the system may identify a set of minimum facts from the extracted facts. For example, the system may compare the extracted facts and information with the format of conduct descriptors for one or more causes of action and identify areas of overlap or correspondence between the conduct descriptors and the extracted facts.

At block 210 the system may receive one or more legal claim records from a data source. The one or more legal claim records may include essential elements or minimum facts of corresponding legal courses of action, such as have been described herein. The minimum facts identified in block 208 may be used as a filter for the kind of legal claim records or causes of action that are likely to be most relevant to the fact pattern provided by the user.

At block 212, the system may provide the extracted facts and the legal claim records (or a database of legal claim records) to a language model. The system may additionally or alternatively provide the entire fact pattern, the minimum facts identified in the extracted facts, and a database of multiple legal claim records to the language model. The database of legal claim records may be configured as a JSON-like string of every item that either has one of the identified minimum facts or has ‘none’ in that field to send to the language model. In some implementations, a small number of legal claim records (e.g., 1, 2, or 3) may be sent to the language model at a time (e.g., asynchronously). The legal claim records may be sent iteratively until all claims have been processed through the language model.

The language model may include or correspond to the language model 122. The system may be configured to generate a query to the language model providing the respective text and data objects with the query. In some implementations, such functionality may be built into a graphical user interface. For example, a query to the language model may be generated and input to the language model on the back end of a GUI without additional input from a user.

At block 214, the system may determine matches between each legal claim record and the extracted facts (e.g., minimum facts) of the fact pattern. The language model may provide an answer or a classification of (a) whether the fact pattern indicates conduct that IS a potentially viable cause of action, (b) whether the fact pattern indicates conduct that is NOT a potentially viable cause of action; (c) or whether, with reasonable additional facts added to the input the fact pattern COULD BE a viable cause of action. Another way of considering the classifications is as an answer of “yes,” “no,” or “additional information needed,” for each of the identified legal claims.

At block 216, the system may use the language model to generate and output a description of the matching, or potentially applicable causes of action that may be brought based on the fact pattern. For example, for any of the answers of yes, to whether a potentially viable cause of action exists in the fact pattern, the language model may describe the cause of action in terms of the facts from the fact pattern giving rise to the potentially viable cause of action. For legal claim records for which an answer of no was determined, no description may be generated.

If multiple potentially viable causes of action are identified, the system may be configured to rank or sort the descriptions of the causes of actions by one or more criteria. Examples of criteria by which causes of action may be ranked, sorted, and displayed to the user may include the commonness or popularity of the cause of action, an amount of alignment between the fact pattern and the essential elements of the cause of action, a higher amount of damages or fees that may be available as a remedy for the cause of action, a lower or higher pleading standard for the cause of action, a higher or lower burden of proof standard for the cause of action, a venue or jurisdiction in which the cause of action may be brought, a likelihood of success in a particular court of bringing the cause of action in the particular court, or some other similar metric by which the outputs may be ranked and displayed to the user. In some instances, a graphical user interface for the output of the language model may be configured to receive inputs that allow a user to change which criteria is used to rank, sort, and display the descriptions. In some configurations, the language model may be prompted to display an explanation for why one claim may be preferred over another.

At optional block 218, the system may determine partial matches between legal claim records and extracted facts. This may be done in a similar manner to the determining of matches identified in block 214. For example, the language model may provide an answer or a classification that there could be a potentially viable cause of action if additional information not present in the fact pattern were true.

At optional block 220, the system may use the language model to generate and output a description of the potentially applicable causes of action that may be brought if additional information were determined. For example, for any of the answers of “additional information needed,” to whether a potentially viable cause of action exists in the fact pattern, the language model may describe the cause of action in terms of the facts from the fact pattern giving rise to the potentially viable cause of action, as well as highlight the kind of facts for which additional information may be needed.

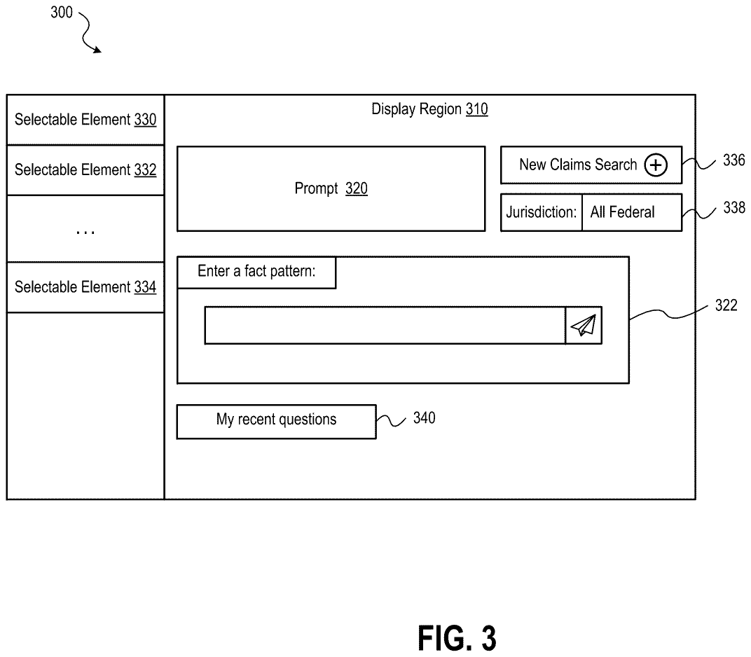

FIG. 3 illustrates an exemplary graphical user interface (GUI) 300 for inputting a statement of facts in accordance with aspects of the present disclosure. GUI 300 may include a display region 310, a prompt 320, a text input element 322, a plurality of selectable elements 330, 332, and 334, a new search selectable element 336, a jurisdiction selectable element 338, and a history or recent questions selectable element 340.

Prompt 320 may include a set of instructions to prompt a user to provide a fact pattern (e.g., a statement of facts) using the text input element 322. For example, the prompt 320 may provide instructions to a user on the structure or content of a fact pattern that may help elicit useful claim recommendations. For example, the prompt 320 may prompt a user to describe a fact pattern in natural language, or to provide a few sentences of description for a fact pattern or for some kind of conduct. In some configurations, prompt 320 may instruct a user in properties of effective fact pattern queries, such as instructions to describe the fact pattern in general language or to describe the types of parties involved, rather than the names of parties. The prompt 320 may also provide caution to a user that the system uses artificial intelligence systems including language models to generate content and that claims identified using the system should be verified with additional research.

In some implementations, prompt 320 may include different prompt templates configured for different analytical tasks. For example, one prompt template may prompt a user to enter a statement of facts as described above. In other examples the prompt 320 may include a prompt template that identifies best practices for formatting the fact pattern for most useful results. In other examples, the prompt 320 may provide example fact patterns or suggest the kinds of information that is helpful in more effectively identifying potential causes of action.

New search selectable element 336 may generate a new search for potentially actionable legal claims. In some configurations, selection of new search selectable element 336 may cause the GUI 300 to clear the text input element 322 of previously entered claims. In other configurations, selection of the new search selectable element 336 may cause the GUI 300 to open a new window or aspect of the GUI. The jurisdiction selectable element 338 may allow a user to determine for which jurisdiction or jurisdictions that potential claims should be evaluated. Based on which jurisdiction is selected at the jurisdiction selectable element 338, the legal claim records and conduct descriptors provided to the language model when evaluating potential legal claims may be adjusted to match causes of action available in the jurisdiction. Jurisdictional filtering may provide a way to improve the speed at which claims are evaluated, at least because fewer jurisdictions means that fewer potential claims will need to be analyzed. Selection of history or recent questions selectable element 340 may present a list of previously entered fact patterns or identified causes of action and allow the user to view the previous results.

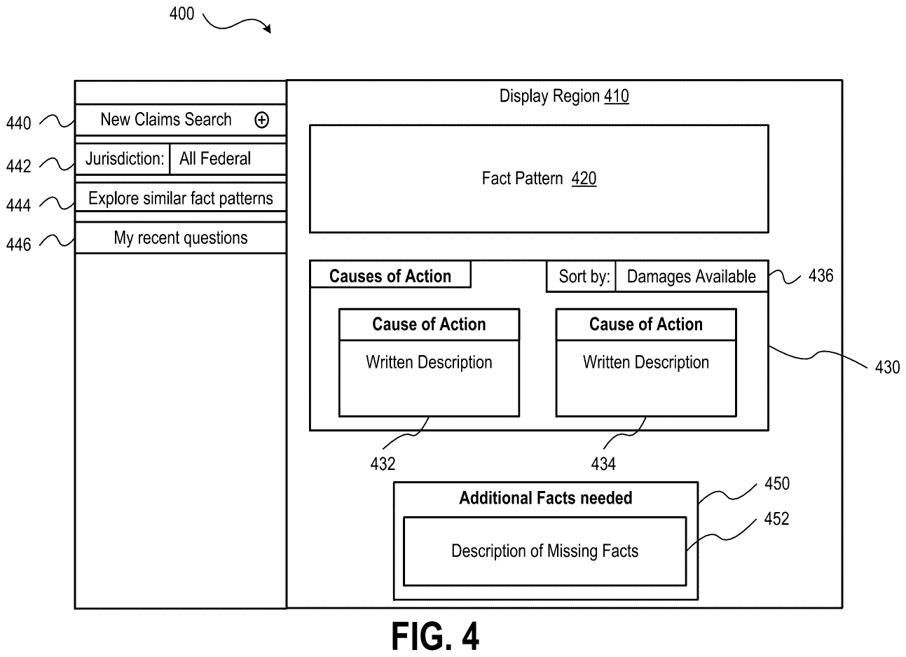

FIG. 4 illustrates an exemplary graphical user interface (GUI) 400 for outputting a legal cause of action in accordance with aspects of the present disclosure. GUI 400 may be illustrative of the kind of output results that may be provided to a user after the user provided a fact pattern at the GUI 300. GUI 400 may include a display region 410; a fact pattern display element 420; a causes of action display element 430; a sorting element 436, a selectable element 440 for generating a new claims analysis or search; selectable element 442 for selecting a jurisdiction for the potential causes of action; selectable element 444 for identifying similar fact patterns from other research; selectable element 446 for identifying recent questions and additional facts display element 450.

The causes of action display element 430 may display causes of action identified by the system as being relevant to the fact pattern a user input. For example, a first cause of action 432 and a second cause of action 434 may be displayed in the causes of action display element 430. While illustrated here as two causes of action, it is understood that several causes of action could be displayed to the GUI 400, to the extent that such causes of action are determined by the system to be relevant to the fact pattern. The causes of action 432 and 434 may include a written description generated by the language model 122 of the system that identifies how the cause of action is met with respect to facts present in the fact pattern. The causes of action 432 and 434 may include or correspond to causes of action for which the system determined that the fact pattern may give rise to the respective causes of action. Causes of action for which no match is identified by the language model may not be displayed to the GUI 400.

While only two causes of action are presented in the example of GUI 400, it should be understood that any number of causes of action may be determined by the system and output to the GUI. In some configurations, the system may generate descriptions of several potential causes of action, with 20-30 different potential causes of action being an example range of the number of cause of action descriptions that may be generated and displayed to the user. In the case that not all the causes of action can adequately fit on one page or within the display region 410, the GUI 400 may be configured to allow scrolling, multiple pages of claims descriptions, collapsible GUI elements, or other similar known methods of making larger amounts of data viewable in a GUI.

Sorting element 436 may be configured to modify the order of the causes of action as presented on the display region 410. The causes of action may be ranked and displayed based on the sorting element selected. Examples of criteria by which causes of action may be ranked, sorted, and displayed to the user may include the commonness or popularity of the cause of action, an amount of alignment between the fact pattern and the essential elements of the cause of action, a higher amount of damages or fees that may be available as a remedy for the cause of action, a lower or higher pleading standard for the cause of action, a higher or lower burden of proof standard for the cause of action, a venue or jurisdiction in which the cause of action may be brought, a likelihood of success in a particular court of bringing the cause of action in the particular court, or some other similar metric by which the outputs may be ranked and displayed to the user.

The sorting element 436 is illustrative of an advantage and benefit of the system in identifying potentially actionable claims and viable causes of action. Identifying multiple potential claims that may be brought for the same conduct can be beneficial, especially when, for example, one cause of action has a lower pleading standard (and thus may be more likely to succeed as a case) or when the amount of damages that may be recovered is higher under one legal framework than another. By configuring the cause of action display to be sortable by one or more different criteria, a user may be given greater understanding of the potential opportunities, advantages, and risks they may face from the options of several potential causes of action.

Additional facts display element 450 may include a display of causes of action that may be brought if additional relevant facts are applicable to the user's fact pattern. Such additional facts may be described with respect to the fact pattern at display element 452. This may advantageously allow a user to provide additional details to the fact pattern for further analysis by the system, or to identify areas where more information is needed before making a decision on the claims that may or should be brought.

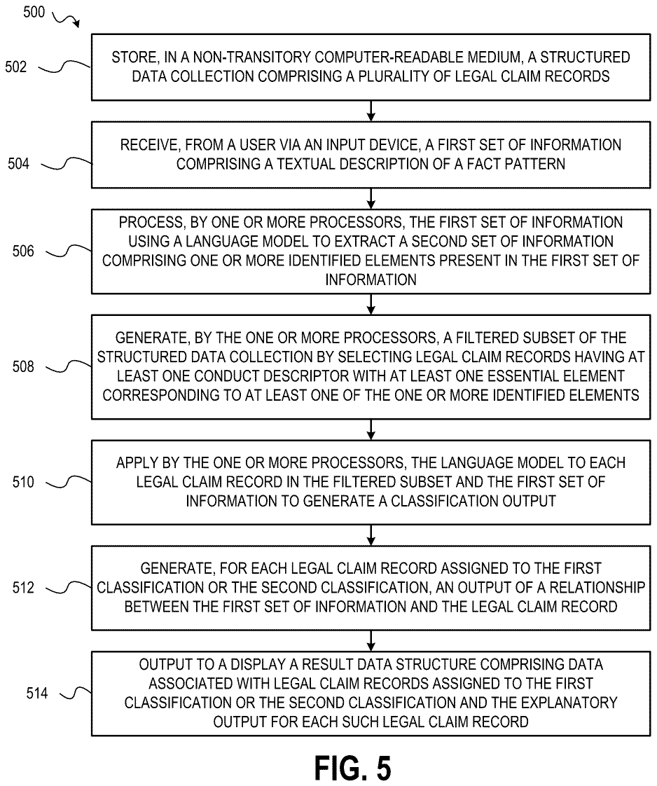

FIG. 5 is a flow diagram of an exemplary method for determining a legal claim in accordance with aspects of the present disclosure, shown as flowchart 500. At block 502, the method may include storing, in a non-transitory computer-readable medium, a structured data collection comprising a plurality of legal claim records. In some configurations, each legal claim record of the plurality of legal claim records may include a record identifier and one or more conduct descriptors corresponding to one or more essential elements of a legal claim. Examples of the structured data collection, the plurality of legal claim records, record identifiers, and conduct descriptors have been discussed herein.

At block 504, the method includes receiving, from a user via an input device, a first set of information comprising a textual description of a fact pattern.

At block 506 the method includes processing, by one or more processors, the first set of information using a language model to extract a second set of information. The second set of information may include one or more identified elements present in the first set of information.

At block 508 the method includes generating, by the one or more processors, a filtered subset of the structured data collection by selecting legal claim records having at least one conduct descriptor with at least one essential element corresponding to at least one of the one or more identified elements. This may be considered an example of identifying a match between essential elements of a legal claim and elements or facts provided in a fact pattern description.

At block 510 the method includes applying, by the one or more processors, the language model to each legal claim record in the filtered subset and the first set of information to generate a classification output. In some configurations, the classification output assigns each legal claim record to one classification selected from a classification set. The classification set may include a first classification indicating the legal claim is supported by the first set of information, a second classification indicating the legal claim requires additional information beyond the first set of information, and a third classification indicating the legal claim is not supported by the first set of information.

At block 512 the method includes generating, by the one or more processors, for each legal claim record assigned to the first classification or the second classification, an output of a relationship between the first set of information and the legal claim record.

At block 514 the method includes outputting, to a display, a result data structure comprising data associated with legal claim records assigned to the first classification or the second classification and the explanatory output for each such legal claim record.

The method described in FIG. 5 is illustrative of the kind of operations that a system such as has been described herein may be configured to perform. Those of ordinary skill in the art would recognize that variations and modifications may be made to the methods, systems, and computer readable media disclosed herein without departing from the scope of this disclosure. For example, in some implementations, processing the first set of information and applying the language model utilize different prompt templates configured for different analytical tasks. In some implementations, applying the language model to each legal claim record in the filtered subset may be performed using parallel processing operations.

In some implementations, the explanatory output for each legal claim record assigned to the second classification may include identification of specific additional information required to satisfy requirements of the legal claim record.

In some implementations, the one or more essential elements of the one or more conduct descriptors for at least one legal claim record may include alternative elements. In some such implementations, the presence of at least one alternative element is sufficient for inclusion of the at least one legal claim record in the filtered subset. In some implementations, the filtered subset may include legal claim records corresponding to subsections of statutory provisions.

In some implementations, each legal claim record in the structured data collection may further include citation data referencing at least one of: a statutory provision, a regulatory provision, or a judicial opinion.

Those of skill in the art would appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

Functional blocks and modules in FIGS. 1-5 may include processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is, one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A computer-implemented method for processing a fact pattern to identify applicable legal claims, the method comprising:
storing, in a non-transitory computer-readable medium, a structured data collection comprising a plurality of legal claim records, where each legal claim record of the plurality of legal claim records comprises a record identifier, and one or more conduct descriptors corresponding to one or more essential elements;
receiving, from a user via an input device, a first set of information comprising a textual description of a fact pattern;
processing, by one or more processors, the first set of information using a language model to extract a second set of information comprising one or more identified elements present in the first set of information;
generating, by the one or more processors, a filtered subset of the structured data collection by selecting legal claim records having at least one conduct descriptor with at least one essential element corresponding to at least one of the one or more identified elements;
applying, by the one or more processors, the language model to each legal claim record in the filtered subset and the first set of information to generate a classification output, wherein the classification output assigns each legal claim record to one classification selected from a classification set comprising:
a first classification indicating the legal claim is supported by the first set of information,
a second classification indicating the legal claim requires additional information beyond the first set of information, and
a third classification indicating the legal claim is not supported by the first set of information;
generating, by the one or more processors, for each legal claim record assigned to the first classification or the second classification, an output of a relationship between the first set of information and the legal claim record; and
outputting, to a display, a result data structure comprising data associated with legal claim records assigned to the first classification or the second classification and the explanatory output for each such legal claim record.

2. The computer-implemented method of claim 1, wherein processing the first set of information and applying the language model utilize different prompt templates configured for different analytical tasks.

3. The computer-implemented method of claim 1, wherein applying the language model to each legal claim record in the filtered subset is performed using parallel processing operations.

4. The computer-implemented method of claim 1, wherein the explanatory output for each legal claim record assigned to the second classification comprises identification of specific additional information required to satisfy requirements of the legal claim record.

5. The computer-implemented method of claim 1, wherein the one or more essential elements of the one or more conduct descriptors for at least one legal claim record comprise alternative elements, wherein presence of at least one alternative element is sufficient for inclusion of the at least one legal claim record in the filtered subset.

6. The computer-implemented method of claim 1, wherein the filtered subset comprises legal claim records corresponding to subsections of statutory provisions.

7. The computer-implemented method of claim 1, wherein each legal claim record in the structured data collection further comprises citation data referencing at least one of: a statutory provision, a regulatory provision, or a judicial opinion.

8. A system for processing a fact pattern to identify applicable legal claims, the system comprising:
a memory; and
one or more processors communicatively coupled to the memory, the one or more processors configured to:
store, in a non-transitory computer-readable medium, a structured data collection comprising a plurality of legal claim records, where each legal claim record of the plurality of legal claim records comprises a record identifier, and one or more conduct descriptors corresponding to one or more essential elements;
receive, from a user via an input device, a first set of information comprising a textual description of a fact pattern;
process the first set of information using a language model to extract a second set of information comprising one or more identified elements present in the first set of information;
generate a filtered subset of the structured data collection by selecting legal claim records having at least one conduct descriptor with at least one essential element corresponding to at least one of the one or more identified elements;
apply the language model to each legal claim record in the filtered subset and the first set of information to generate a classification output, wherein the classification output assigns each legal claim record to one classification selected from a classification set comprising:
a first classification indicating the legal claim is supported by the first set of information,
a second classification indicating the legal claim requires additional information beyond the first set of information, and
a third classification indicating the legal claim is not supported by the first set of information;
generate, for each legal claim record assigned to the first classification or the second classification, an output of a relationship between the first set of information and the legal claim record; and
output to a display a result data structure comprising data associated with legal claim records assigned to the first classification or the second classification and the explanatory output for each such legal claim record.

9. The system of claim 8, wherein processing the first set of information and applying the language model utilize different prompt templates configured for different analytical tasks.

10. The system of claim 8, wherein applying the language model to each legal claim record in the filtered subset is performed using parallel processing operations.

11. The system of claim 8, wherein the explanatory output for each legal claim record assigned to the second classification comprises identification of specific additional information required to satisfy requirements of the legal claim record.

12. The system of claim 8, wherein the one or more essential elements of the one or more conduct descriptors for at least one legal claim record comprise alternative elements, wherein presence of at least one alternative element is sufficient for inclusion of the at least one legal claim record in the filtered subset.

13. The system of claim 8, wherein the filtered subset comprises legal claim records corresponding to subsections of statutory provisions.

14. The system of claim 8, wherein each legal claim record in the structured data collection further comprises citation data referencing at least one of: a statutory provision, a regulatory provision, or a judicial opinion.

15. A non-transitory computer readable storage medium storing instructions that, when executed by one or more processors, cause the one or more processors to perform operations for processing a fact pattern to identify applicable legal claims, the operations comprising:
storing, in a database, a structured data collection comprising a plurality of legal claim records, where each legal claim record of the plurality of legal claim records comprises a record identifier, and one or more conduct descriptors corresponding to one or more essential elements;
receiving, from a user via an input device, a first set of information comprising a textual description of a fact pattern;
processing the first set of information using a language model to extract a second set of information comprising one or more identified elements present in the first set of information;
generating a filtered subset of the structured data collection by selecting legal claim records having at least one conduct descriptor with at least one essential element corresponding to at least one of the one or more identified elements;
applying the language model to each legal claim record in the filtered subset and the first set of information to generate a classification output, wherein the classification output assigns each legal claim record to one classification selected from a classification set comprising:
a first classification indicating the legal claim is supported by the first set of information,
a second classification indicating the legal claim requires additional information beyond the first set of information, and
a third classification indicating the legal claim is not supported by the first set of information;
generating for each legal claim record assigned to the first classification or the second classification, an output of a relationship between the first set of information and the legal claim record; and
outputting, to a display, a result data structure comprising data associated with legal claim records assigned to the first classification or the second classification and the explanatory output for each such legal claim record.

16. The non-transitory computer readable storage medium of claim 15, wherein processing the first set of information and applying the language model utilize different prompt templates configured for different analytical tasks.

17. The non-transitory computer readable storage medium of claim 15, wherein applying the language model to each legal claim record in the filtered subset is performed using parallel processing operations.

18. The non-transitory computer readable storage medium of claim 16, wherein the explanatory output for each legal claim record assigned to the second classification comprises identification of specific additional information required to satisfy requirements of the legal claim record.

19. The non-transitory computer readable storage medium of claim 15, wherein the one or more essential elements of the one or more conduct descriptors for at least one legal claim record comprise alternative elements, wherein presence of at least one alternative element is sufficient for inclusion of the at least one legal claim record in the filtered subset.

20. The non-transitory computer readable storage medium of claim 15, wherein each legal claim record in the structured data collection further comprises citation data referencing at least one of: a statutory provision, a regulatory provision, or a judicial opinion.
